(19) United States
(12) Patent Application Publication
(10) Pub. No.: US 2013/0085860 A1
(43) Pub. Date: Apr. 4, 2013

(54) SYSTEMS AND METHODS TO DELIVER CONTEXT SENSITIVE DYNAMIC MOBILE ADVERTISEMENTS

(71) Applicants: Joshua Summers, Lexington, MA (US); Markus Wuersch, Charlestown, MA (US); Ronald J. Braunfeld, Bala Cynwyd, PA (US); Ivan Mitrovic, Charlestown, MA (US)

(72) Inventors: Joshua Summers, Lexington, MA (US); Markus Wuersch, Charlestown, MA (US); Ronald J. Braunfeld, Bala Cynwyd, PA (US); Ivan Mitrovic, Charlestown, MA (US)

(73) Assignee: eBay Inc., San Jose, CA (US)

(21) Appl. No.: 13/624,599

(22) Filed: Sep. 21, 2012

Related U.S. Application Data
(60) Provisional application No. 61/543,187, filed on Oct. 4, 2011.

(51) Int. Cl. G06Q 30/02; G06F 15/16

(52) U.S. Cl. 705/14.58; 705/14.64

(57) ABSTRACT

Systems and methods for delivering context sensitive dynamic mobile advertisements are discussed. In an example, a method for delivering context sensitive dynamic mobile advertisements can include receiving user-related context data, generating an advertisement, transmitting the advertisement, updating a dynamic content portion of the advertisement, and transmitting at least the updated dynamic content portion. The advertisement is generated based at least in part on the user-related context data, and includes the dynamic content portion to display dynamic data related to the user-related context data.

### CROSS-REFERENCE TO RELATED APPLICATION

This application claims the benefit of U.S. Provisional Application No. 61/543,187, titled “Systems and Method to Deliver Context Sensitive Dynamic Mobile Advertisements,” filed Oct. 4, 2011, which is incorporated herein by reference in its entirety.

### TECHNICAL FIELD

This application relates generally to data processing within a network-based system operating over a distributed network, and more specifically to systems and methods to deliver context sensitive dynamic mobile advertisements.

### BACKGROUND

The ever increasing use of smart phones, such as the iPhone® (from Apple, Inc. of Cupertino, Calif.), with data connections and location determination capabilities is slowly changing the way people shop for products and services, find restaurants and entertainment events, and receive. Smart phones can provide users with mobile access to the Internet that is quickly becoming fast and ubiquitous. Smart phones also commonly include mechanisms, such as GPS receivers, that allow the devices to constantly update location information.

### BRIEF DESCRIPTION OF THE DRAWINGS

Some embodiments are illustrated by way of example and not limitation in the figures of the accompanying drawings in which:

FIG. 1 is a block diagram depicting a system for delivering context sensitive dynamic mobile advertisements, according to an example embodiment.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based system for delivering context sensitive dynamic mobile advertisements, according to an example embodiment.

FIG. 5 is a block diagram illustrating publication modules, according to an example embodiment.

FIG. 6 is a flowchart illustrating a method for delivering context sensitive dynamic mobile advertisements, according to an example embodiment.

FIG. 7 is a flowchart illustrating a method for receiving context sensitive dynamic advertisements, according to an example embodiment.

FIG. 8 is a swim-lane chart illustrating a method for providing location-aware offers based on missed purchase opportunities, according to an example embodiment.

FIG. 9A-9I are diagrams illustrating an example context sensitive dynamic mobile advertisements, according to various example embodiments.

FIG. 10 is a diagrammatic representation of a machine in the example form of a computer system within which a set of instructions for causing the machine to perform any one or more of the methodologies discussed herein may be executed.

### DEFINITIONS

Location—For the purposes of this specification and the associated claims the term “location” is used to refer to a geographic location, such as a longitude/latitude combination or a street address. The term location is also used within this specification in reference to a physical location associated with a retail outlet (e.g., store) other similar physical locations.

Real-time—For the purposes of this specification and the associated claims the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine. Further, introducing artificial delays between input and response should not cause the functionality to be outside the scope of real-time, unless the delay serves a particular purpose.

### DETAILED DESCRIPTION

Example systems and methods for generating, delivering, and updating context sensitive dynamic advertisements are described. The systems and methods for generating, delivering, and updating context sensitive dynamic advertisements, in some example embodiments may provide advertisers the ability to target customers based on current context (e.g., location) of a user interacting with a network-based publication system. In the following description, for purposes of explanation, numerous specific details are set forth in order to provide a thorough understanding of example embodiments. It will be evident, however, to one skilled in the art that the present invention may be practiced without these specific details. It will also be evident, that an offer publication system for generating, delivering, and updating context sensitive dynamic advertisements is not limited to the examples provided and may include other scenarios not specifically discussed.

In accordance with an example embodiment, a network-based system can provide a platform to generate, deliver, and update context sensitive dynamic advertisements. In certain examples, the context used to target, generate, and update the dynamic advertisements can include location, events, weather, inventory, flight information, or time of day, to name just a few. In some examples, the user interacts with a network-based system via a mobile device, such as a smartphone, a tablet computing device, or Internet enabled personal digital assistant (PDA), among others. In an example, the network-based system can include a publication module capable of generating, delivering, and updating context sensitive dynamic advertisements.

In an example scenario, the network-based publication system can generate dynamic advertisements that include location related information that is updated in real-time as a user moves around. In this example, the user can interact with the network-based publication system via a mobile device that includes location determination capabilities. During interaction with the network-based publication system, the mobile device can continuously update the user's location. In turn, the network-based publication system can generate, deliver, and update advertisements that include location information or other contextual information that may or may not be location related. For example, the network-based publication system can generate an advertisement that includes the distance to the nearest outlet for the particular advertiser. The distance information can be dynamically updated to account for movement by the mobile device.

In another example scenario, the network-based publication system can combine location and event data associated with the location to produce a dynamic advertisement that contains up-to-date information relevant to the user's current location. For example, the owner of a local theater could use the network-based publication system to publish dynamic advertisements that include a list of movies and show times for the particular day of the week, another example, the network-based publication system can generate advertisements that include real-time score updates from a local sporting event occurring within a certain distance of the user.

In an example, the network-based publication system can use context information to dynamically target advertisement generation and delivery. For example, advertisements for suntan lotion can be triggered if the network-based system detects that the local temperature has exceeded 80° F. and the sun is shining (e.g., analysis of weather information). In another example, vendors within an airport can use the network-based publication system to advertise currently available inventory that may be of interest to a traveler whenever there is a flight delay advisory issued. In yet another example, the network-based publication system can access local inventory for a marketplace, such as eBay Motors (from eBay, Inc. of San Jose, Calif.) and can display relevant listings based on a user's current location. In this example, the advertisement can include bid information and distance to the item (e.g., based on zip code or physical address). Advertisement targeting can be performed based on any internal or external data that can be used to define a reason to target a user. For example, advertisements can be targeted based on congressional districts that have a congress person that voted yes on a particular bill or target users within all Starbucks were 50 or more people have checked-in over the last 24 hour period.

In certain examples, the network-based publication system can use trigger events to initiate the publication (e.g., delivery) of certain advertisements. Examples can include: weather events (e.g., an advisory for temperatures exceeding 100° F.), medical events (e.g., a flu outbreak advisory), inventory events (e.g., a sale at a participating merchant), or travel events (e.g., a flight delay advisory), among others. The information presented within the advertisement may also be contextual to the event (e.g., the temperature advisory may be provided within the context of a suntan lotion advertisement).

The following two tables list examples of dynamic advertisement content (Table 1 ) and dynamic advertisement targeting criteria (Table 2 ). The following tables are only presented as examples and are not meant to present exhaustive lists:

TABLE 1
Dynamic Advertisement Content

Point of Interest (POI)
Distance (based on user location)
Events
User Location
Weather
Flight Delays
Stock Alerts
News
Inventory
Sports Scores
TV Listings (based on time of day, day of week and/or
location)
Movie ShowTime's and Locations

TABLE 2
Dynamic Targeting Criteria

Weather Alerts (NOAA, Accuweather)
Fight Delays (FAA)
Sport Scores (Tuner Sports, etc . . . )
Pricing
Inventory
Number of New Home Sales
Number of Houses on the Market in a particular Area
Number of Check-ins at a Location (e.g., Foursquare)
Tweets

### Example System

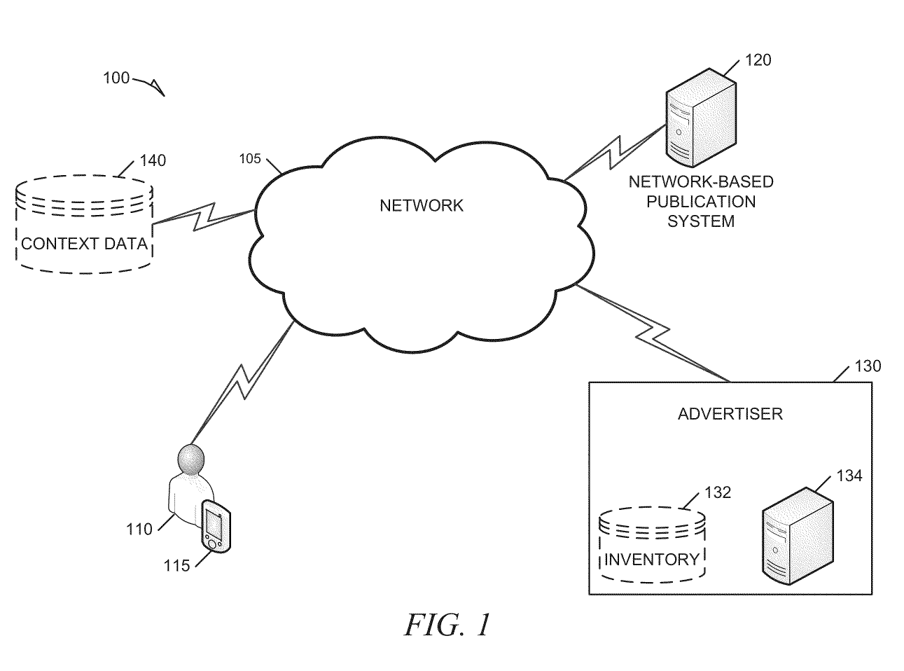

FIG. 1 is a block diagram depicting a system 100 for generating, delivering, and updating context sensitive dynamic advertisements, according to an example embodiment. The system 100 can include a user 110, a network-based publication system 120, an advertiser 130, and optionally one or more external sources of context data, represented by context data 140. In an example, the user 110 can connect to the network-based publication system 120 via a mobile device 115 (e.g., smart phone, PDA, laptop, or similar mobile electronic device capable of some form of data connectivity). In an example, the advertiser 130 can operate computer systems, such as an inventory system 132 or a merchandizing system 134. The network-based publication system 120 can interact with any of the systems used by the advertiser 130 for operation of the advertiser's retail or service business. In an example, the network-based publication system 120 can work with both merchandizing system 134 and inventory system 132 to obtain access to inventory available at individual retail locations run by the merchant (e.g., context information). For example, the merchant 130 can create rule-based instructions for use by the network-based publication system 120 in generating advertisements based on available inventory and that include dynamic inventory information. In an example, the merchant 130 can access the network-based publication system 130 via a web interface to create rule-based instructions for use in generating advertisements.

### Example Operating Environment

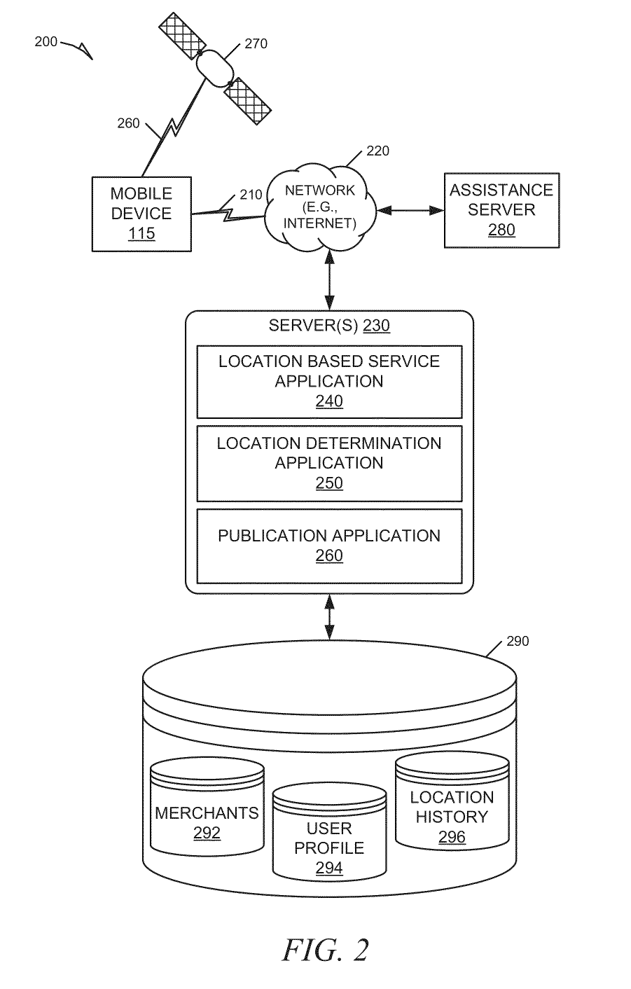

FIG. 2 is a block diagram illustrating an environment 200 for operating a mobile device 115, according to an example embodiment. The environment 200 is an example environment within which methods of generating, delivering, and updating dynamic mobile advertisements can be performed. The mobile device 115 represents one example device that can be utilized by a user to receive advertisements and share context information with a network-based publication system, such as network-based publication system 120. The mobile device 115 may be any of a variety of types of devices, for example a cellular telephone, a personal digital assistant (PDA), a Personal Navigation Device (PND), a handheld computer, a tablet computer, a notebook computer, or other type of movable device. The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone, for example, the public switched telephone network (PSTN), a packet-switched data network, or to other types of networks.

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a local area network (LAN), a wide area network (WAN), the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. For example, one or more servers 230 may execute location based service (LBS) applications 240, which interoperate with software executing on the mobile device 115, to provide LBS's to a user. LBS's can use knowledge of the device's location, and/or the location of other devices, to provide location-specific information, recommendations, notifications, interactive capabilities, and/or other functionality to a user. For example, an LBS application 240 can provide location data to a network-based publication system 120, which can then be used to assist in generating offers relevant to the user's current location. Knowledge of the device's location, and/or the location of other devices, may be obtained through interoperation of the mobile device 115 with a location determination application 250 executing on one or more of the servers 230. Location information may also be provided by the mobile device 115, without use of a location determination application, such as application 250. In certain examples, the mobile device 115 may have some limited location determination capabilities that are augmented by the location determination application 250. In some examples, the servers 230 can also include publication application 260 for providing location-aware offers that may be triggered by past missed purchase opportunities. In certain examples, location data can be provided to the publication application 260 by the location determination application 250. In some examples, the location data provided by the location determination application 250 can include merchant information (e.g., identification of a retail location). In certain examples, the location determination application 250 can receive signals via the network 120 to further identify a location. For example, a merchant may broadcast a specific IEEE 802.11 service set identifier (SSID) that can be interpreted by the location determination application 250 to identify a particular retail location. In another example, the merchant may broadcast an identification signal via radio-frequency identification (RFID), near-field communication (NEC), or similar protocol that can be used by the location determination application 250.

### Example Mobile Device

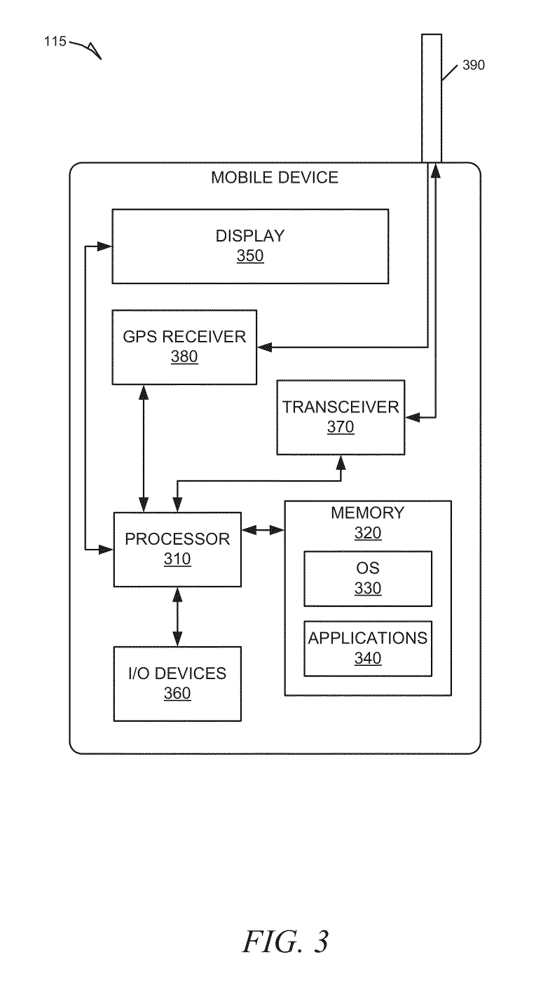

FIG. 3 is a block diagram illustrating the mobile device 115, according to an example embodiment. The mobile device 115 may include a processor 310. The processor 310 may be any of a variety of different types of commercially available processors suitable for mobile devices, for example, an XScale architecture microprocessor, a Microprocessor without Interlocked Pipeline Stages (MIPS) architecture processor, or another type of processor. A memory 320, such as a Random Access Memory (RAM), a Flash memory, or other type of memory, is typically accessible to the processor. The memory 320 may be adapted to store an operating system (OS) 330, as well as application programs 340, such as a mobile location enabled application that may provide LBS's to a user. The processor 310 may be coupled, either directly or via appropriate intermediary hardware, to a display 350 and to one or more input/output (I/O) devices 360, such as a keypad, a touch panel sensor, a microphone, etc. Similarly, in some embodiments, the processor 310 may be coupled to a transceiver 370 that interfaces with an antenna 490. The transceiver 470 may be configured to both transmit and receive cellular network signals, wireless data signals, or other types of signals via the antenna 390, depending on the nature of the mobile device 115. In this manner the connection 310 with the communication network 320 may be established. Further, in some configurations, a GPS receiver 380 may also make use of the antenna 390 to receive GPS signals.

Additional detail regarding providing and receiving location-based services can be found in U.S. Pat. No. 7,848,765, Titled “Location-Based Services,” granted to Phillips et al. and assigned to Where, Inc. of Boston, Mass., which is hereby incorporated by reference.

An important geo-location concept discussed within U.S. Pat. No. 7,848,765 is a geofence. A geofence can be defined as a perimeter or boundary around a physical location. A geofence can be as simple as a radius around a physical location, defining a circular region around the location. However, a geofence can be any geometric shape or an arbitrary boundary drawn on a map. A geofence can be used to determine a geographical area of interest for calculation of demographics, advertising, or similar purposes. Geofences can be used in conjunction with the advertisement generation and delivery concepts discussed herein. For example, a geofence can be used to assist in determining whether a user (or mobile device associated with the user) is within a geographic area of interest to a particular advertiser (e.g., local merchant). If the user is within a geofence established by the merchant, the systems discussed herein can use that information to generate a dynamic advertisement from the merchant and deliver the over to the user (e.g., via a mobile device associated with the user).

### Example Platform Architecture

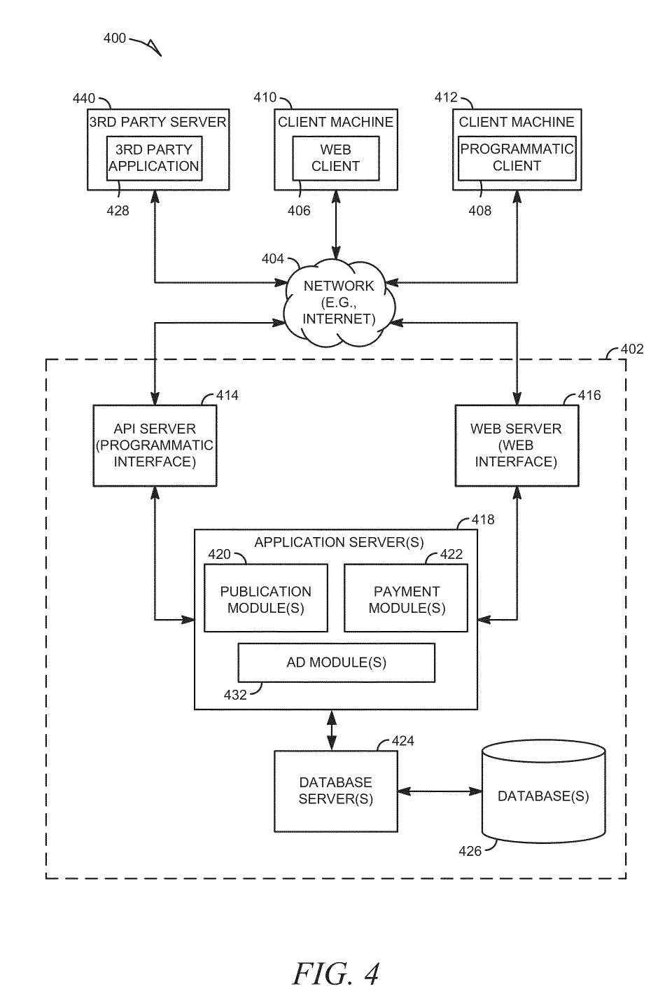

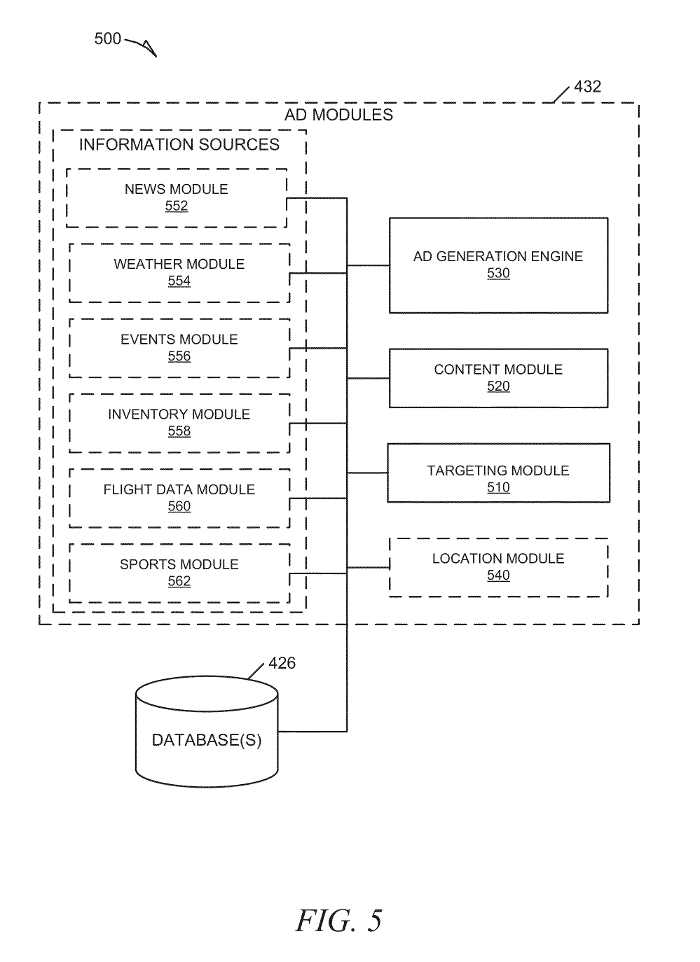

FIG. 4 is a block diagram illustrating a network-based system 400 for generating, delivering, and updating context sensitive dynamic advertisements, according to an example embodiment. The block diagram depicting a client-server system 400, within which an example embodiment can be deployed is described. A networked system 402, in the example forms of a network-based location-aware publication, advertisement, or marketplace system, that provides server-side functionality, via a network 404 (e.g., the Internet or Wide Area Network (WAN)) to one or more clients 410, 412. FIG. 5 illustrates, for example, a web client 406 (e.g., a browser, such as the Internet Explorer browser developed by Microsoft Corporation of Redmond, Wash. State), and a programmatic client 408 (e.g., WHERE smartphone application from Where, Inc. of Boston, Mass.) executing on respective client machines 410 and 412. In an example, the client machines 410 and 412 can be in the form of a mobile device, such as mobile device 115.

An Application Programming Interface (API) server 414 and a web server 416 are coupled to, and provide programmatic and web interfaces respectively to, one or more application servers 418. The application servers 418 host one or more publication modules 420 (in certain examples these can also include commerce modules, advertising modules, and marketplace modules, to name a few), payment modules 422, and context sensitive ad modules 432. The application servers 418 are, in turn, shown to be coupled to one or more database servers 424 that facilitate access to one or more databases 426. In some examples, the application server 418 can access the databases 426 directly without the need for a database server 424.

The publication modules 420 may provide a number of publication functions and services to users that access the networked system 402. The payment modules 422 may likewise provide a number of payment services and functions to users. The payment modules 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues. The payment modules 422 may also be configured to present or facilitate redemption of offers, included within advertisements generated by the ad modules 432, to a user during checkout (or prior to checkout, while the user is still actively shopping). The context sensitive ad modules 432 may provide real-time location-aware advertisements to users of the networked system 402. The context sensitive ad modules 432 can be configured to use all of the various communication mechanisms provided by the networked system 402 to present advertisements to users. Alterative, the ad modules 432 can provide context sensitive dynamic advertisements to the publication modules 420 for delivery. The advertisements can be dynamically personalized based on current location, time of day, user profile data, past purchase history, or recent physical or online behaviors recorded by the network-based system 400, among other things. While the publication modules 420, payment modules 422, and ad modules 432 are shown in FIG. 4 to all form part of the networked system 402, it will be appreciated that, in alternative embodiments, the payment modules 422 may form part of a payment service that is separate and distinct from the networked system 402. Additionally, in some examples, the ad modules 432 may be part of the payment service or may form an advertisement generation service separate and distinct from the networked system 402.

Further, while the system 400 shown in FIG. 4 employs a client-server architecture, the present invention is of course not limited to such an architecture, and could equally well find application in a distributed, or peer-to-peer, architecture system, tier example. The various publication modules 420, payment modules 422, and ad modules 432 could also be implemented as standalone systems or software programs, which do not necessarily have networking capabilities.

The web client 406 accesses the various publication modules 420, payment modules 422, and ad modules 432 via the web interface supported by the web server 416. Similarly, the programmatic client 408 accesses the various services and functions provided by the publication modules 420, payment modules 422, and ad modules 432 via the programmatic interface provided by the API server 414. The programmatic client 408 may, for example, be a smartphone application (e.g., the WHERE application developed by Where, Inc., of Boston, Mass.) to enable users to receive context sensitive dynamic advertisements on their smartphones leveraging available context data, such as user profile data and current location information provided by the smartphone or accessed over the network 404.

FIG. 4 also illustrates a third party application 428, executing on a third party server machine 430, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide advertisers with access to the ad modules 432 for configuration purposes. In certain examples, advertisers can use programmatic interfaces provided by the API server 414 to develop and implement rules-based ad schemes (e.g., campaigns) that can be implemented via the publication modules 420, payment modules 422, and ad modules 432.

### Example Ad Modules

FIG. 5 is a block diagram illustrating context sensitive advertisement modules (ad modules 432), according to an example embodiment. In this example, the ad modules 432 can include a targeting module 510, a content module 520, an ad generation module 530, and various information sources for context information. Optionally, the ad modules 432 can also include a location module 540. Context information sources can include a news module 552, a weather module 554, an events module 556, an inventory module 558, a flight data module 560, and a sports module 562, to name just a few. In an example, the ad modules 432 can access database 426 to store and/or retrieve advertisement rules and campaign information, context data, location data, as well as other information to enable context sensitive advertisements to be generated, delivered, and updated.

In an example, the content module 520 can gather and deliver context relevant content to the ad generation module 530 based on advertisement rules and campaign information provided by advertisers. The content module 520 can interface with each of the various context information sources to obtain and dynamically update advertisement content.

In an example, the targeting module 510 can use context information from the various information sources to dynamically target advertisements to users based on the current context (e.g., location, time, events, weather, and the like).

In an example, the location module 540 is configured to receive location data from a mobile device, such as mobile device 115, and determine from the location data one or more participating merchant locations that are within a pre-define proximity. In some examples, the location module 540 can receive GPS-type coordinates (e.g., longitude and latitude), which can be used to establish a current location associated with a mobile device (and thus a user of the mobile device). Using the longitude and latitude coordinates, the location module 540 can determine if any merchants with physical locations registered with the networked system 402 are in proximity to the current location associated with the user. In certain examples, the location module 540 can receive other location determining information from a mobile device. For example, some merchants may broadcast specific wireless network signals that can be received by a mobile device, such as mobile device 115. Once received, the mobile device 115 can include programming or circuitry to translate the signal into a specific location or the mobile device 115 can simply retransmit the unique signal to the location module 540. In an example, a merchant location can transmit a unique SSID, which the location module can be programmed to interpret as identifying a specific merchant location. In another example, the merchant may broadcast a unique SSID within all of its locations and the location module 540 can be programmed to use a combination of the unique SSID and other location data (e.g., GPS coordinates or cell tower locations) to identify a specific location.

In an example, the news module 552 can access various sources of news information over the network 404. The news module 552 can receive keywords from the ad generation engine 530 related to advertisement content or rules that trigger based on specific news stories or events.

In an example, the weather module 554 can access and deliver weather related data and alerts to the ad generation engine 530. In certain examples, the weather module 554 can receive location data from the location module 540 to target the weather data gathering. In some examples, the ad generation engine 530 can query the weather module 554 for information such as, local temperature, weather alerts, forecast, among other things.

In an example, the event module 556 can access and deliver local event information to the ad generation module 530. For example, the event module 556 can receive location information from the location module 540 and based on the location information provide data on local sporting events, theater information, and other event or festival information for the location.

In an example, the inventory module 558 can track inventory available at individual locations associated with a merchant using the networked system 402. The inventory module 558 can maintain inventory associated with products or services that merchant has included within offer generation rules used by the ad generation engine 530 to generate context sensitive advertisements. In certain examples, the inventory module 558 maintains inventory information within a local database, such as database 426. In another example, the inventory module 558 can be configured to access remote inventory information maintained by individual merchants. In additional examples, the inventory module 558 can be configured to interact with a third-party real-time inventory provider, such as MILO (from eBay, Inc. of San Jose, Calif.). The inventory module 558 can also be configured to delivery real-time (or near real-time) inventory information from multiple different sources. In some examples, each merchant may make inventory information available via different mechanism (e.g., API, XML feed, batch up loads, etc . . . ). The inventory module 558 can convert from various incoming formats to a common format used by the ad generation engine 530 to generate context sensitive dynamic advertisements based on current inventory available within individual local retail outlets.

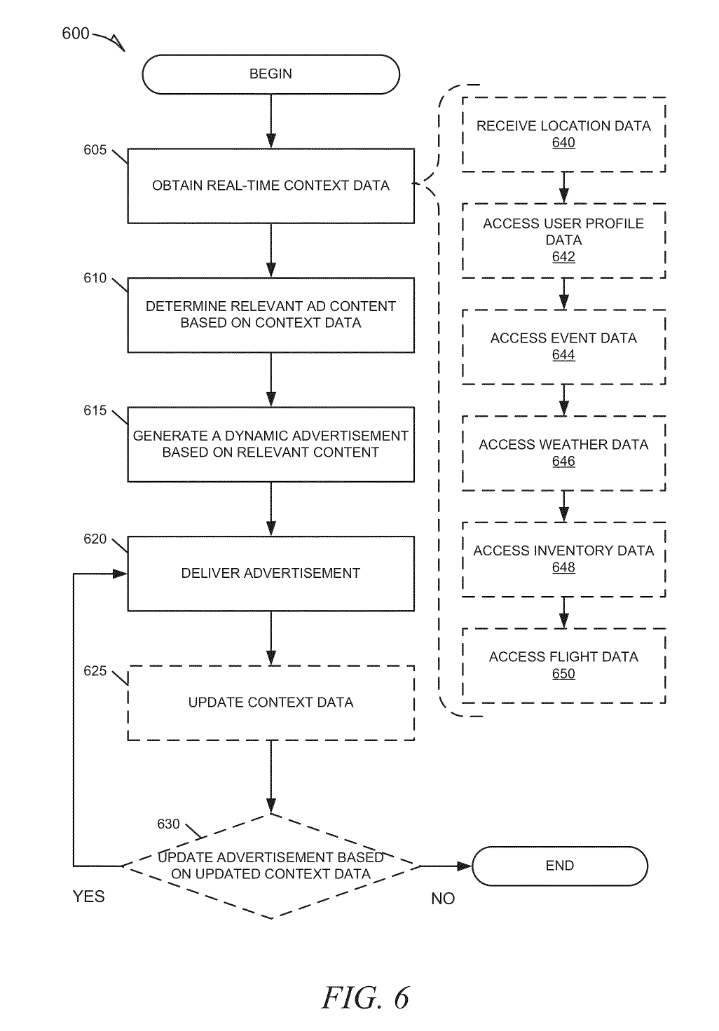

Additional details regarding the functionality provided by the location-aware offer modules 432 are detailed in reference to FIGS. 6-8.

### Example Methods

FIG. 6 is a flowchart illustrating a method 600 for generating, delivering, and updating context sensitive dynamic mobile advertisements, according to an example embodiment. In an example, the method 600 can include operations for obtaining context data at 605, determining relevant ad content at 610, generating an advertisement at 615, delivering the advertisement at 620, optionally updating context data at 625, and optionally determining whether to update the advertisement at 620. In this example, the method 600 can include the following operations to obtain real-time context data at 605, receiving location data at 640, accessing user profile data at 642, accessing event data at 644, accessing weather data at 646, accessing inventory data at 648, and accessing flight data at 650. The illustrated examples of context data (640-650) are merely exemplary and should not be considered limiting.

In an example, the method 600 can being at 605 with the ad generation engine 530 obtaining real-time context data. In another example, the content module 520 can obtain the real-time context data from the various context information sources (e.g., modules 552-562). At 610, the method 600 can continue with the ad generation engine 530 determining relevant ad content based on the context data. In certain examples, the ad generation engine 530 can request the relevant content from the content module 520.

At 615, the method 600 can continue with the ad generation engine 530 generating a dynamic advertisement based on the relevant content. At 620, the method 600 can continue with the publication module 420 delivering the advertisement generated by the ad generation module 530. At 625, the method 600 can continue with the ad modules 432 updating context data. In certain examples, the ad modules 432 can periodically check for updated context data (e.g., once every 30 seconds). In other examples, real-time context data feeds, such as context data accessed in operations 640 through 650, can be configured to push updates and trigger operation 625. At 630, the method 600 continues with the ad modules 432 determining whether to update the advertisement based on the updated context data. If the advertisement is updated, the method 600 continues by looping back to 620 with the publication module 420 delivering an updated version of the advertisement. In some examples, the updated content can be pushed out automatically to the advertisement. If the dynamic content stops updating the method 600 can end. In certain examples, the method 600 can continue looping to continue checking for updated context data, among other things.

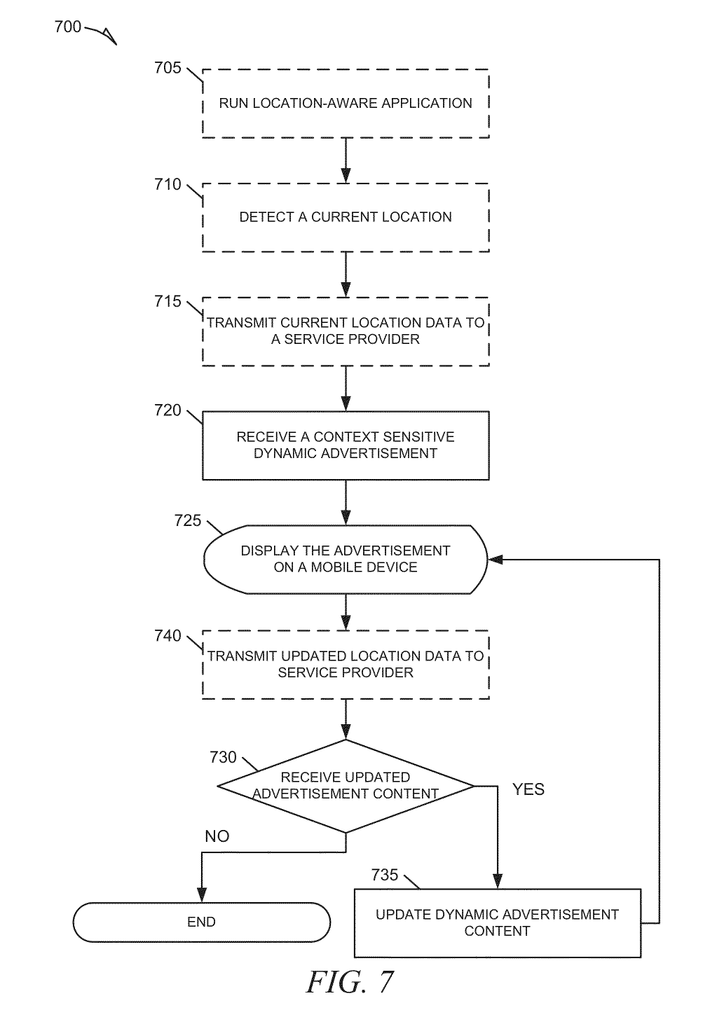

FIG. 7 is a flowchart illustrating a method 700 for receiving context sensitive dynamic advertisements, according to an example embodiment. In an example, the method 700 can include operations for receiving a context sensitive dynamic advertisement at 720, displaying the advertisement at 725, determining if updated advertisement content is received at 730, and updating the dynamic advertisement content at 735. Optionally, the method 700 can also include operations for running a location-aware application at 705, detecting a current location at 710, transmitting the current location data to a service provider at 715, and transmitting updated location data to a service provider at 740. The operations outlined in method 700 can all occur within a mobile device, such as mobile device 115.

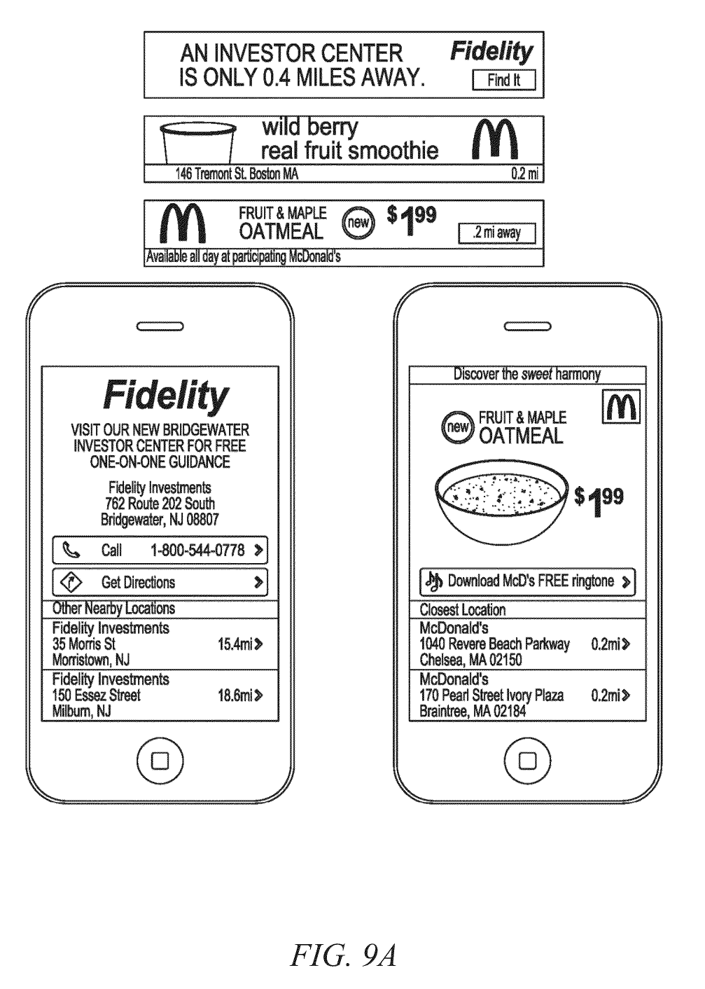

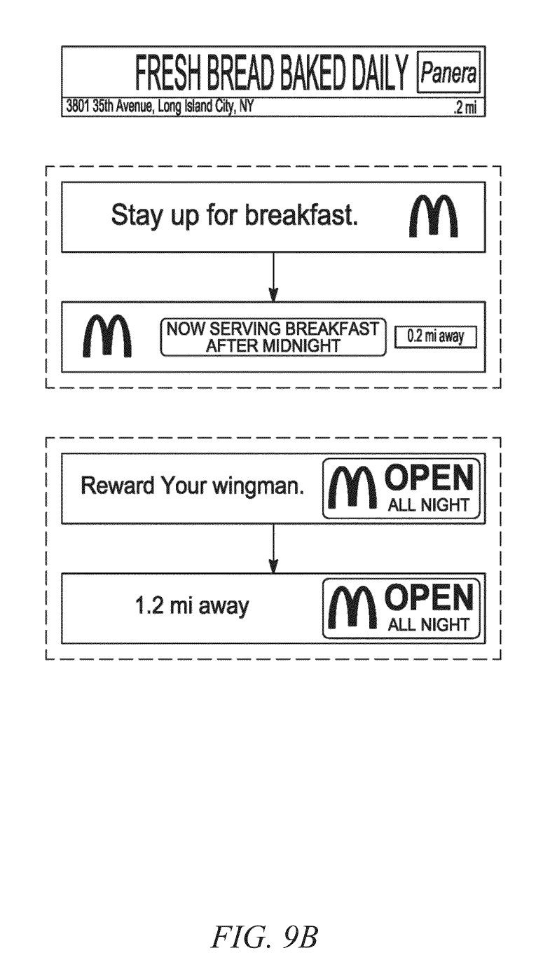

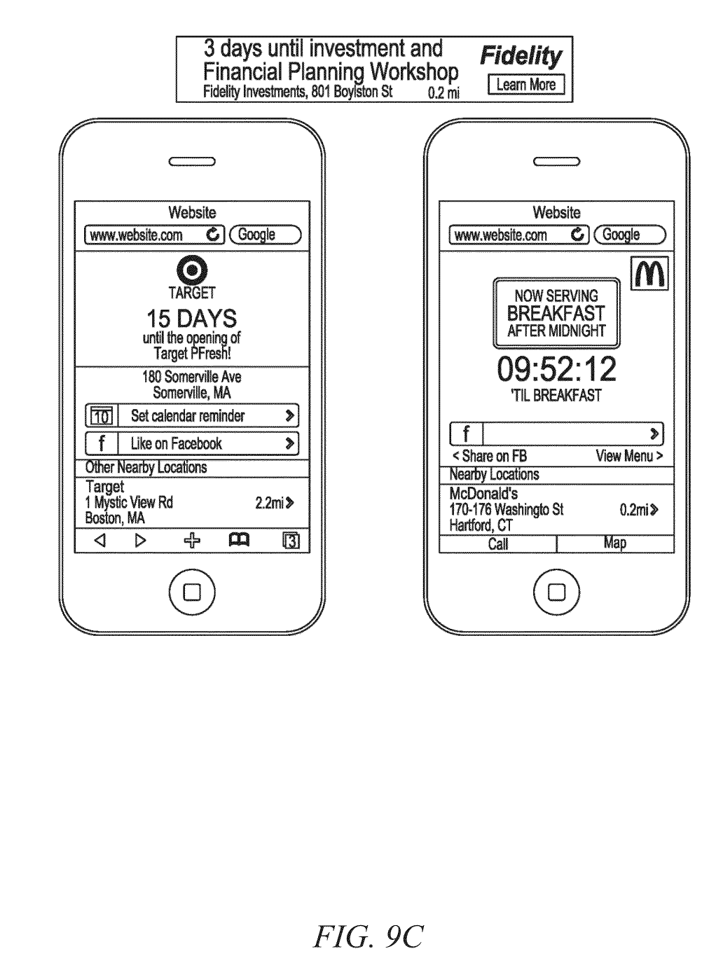

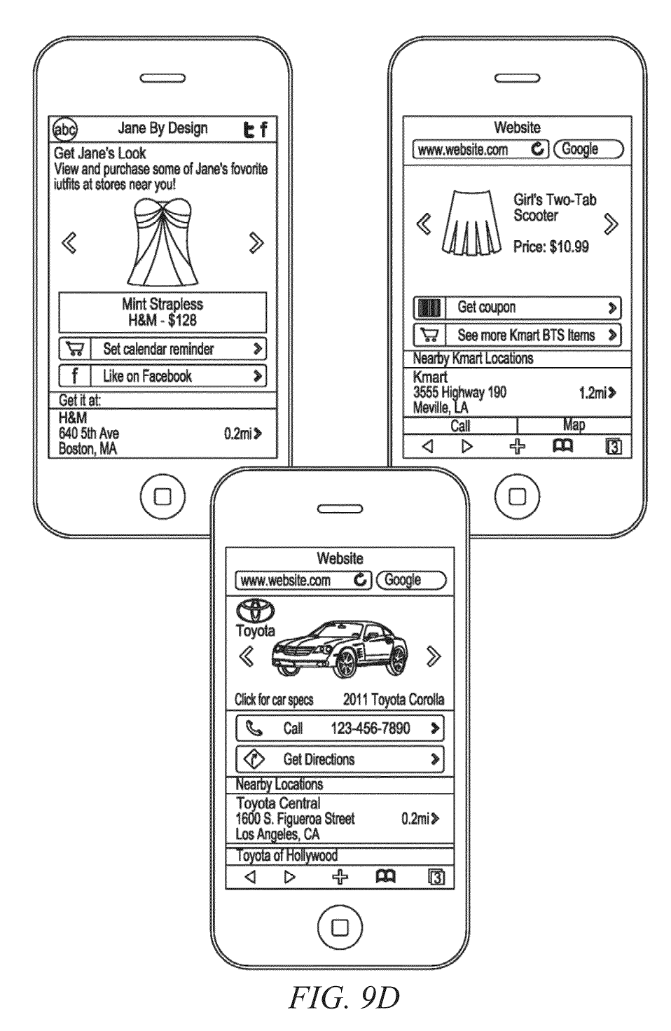

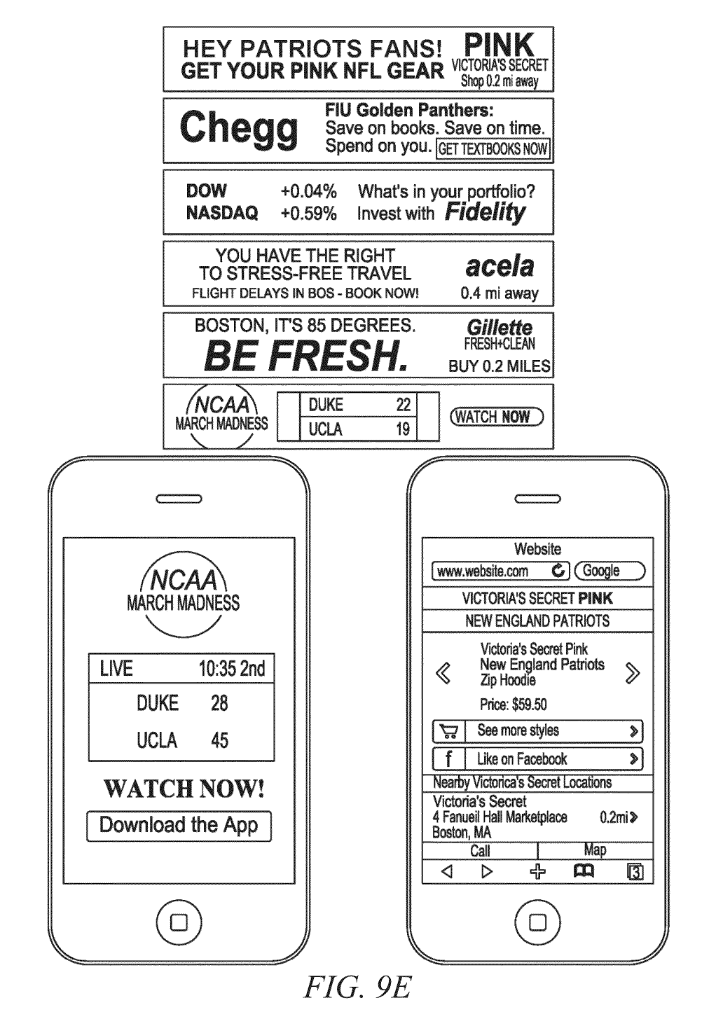

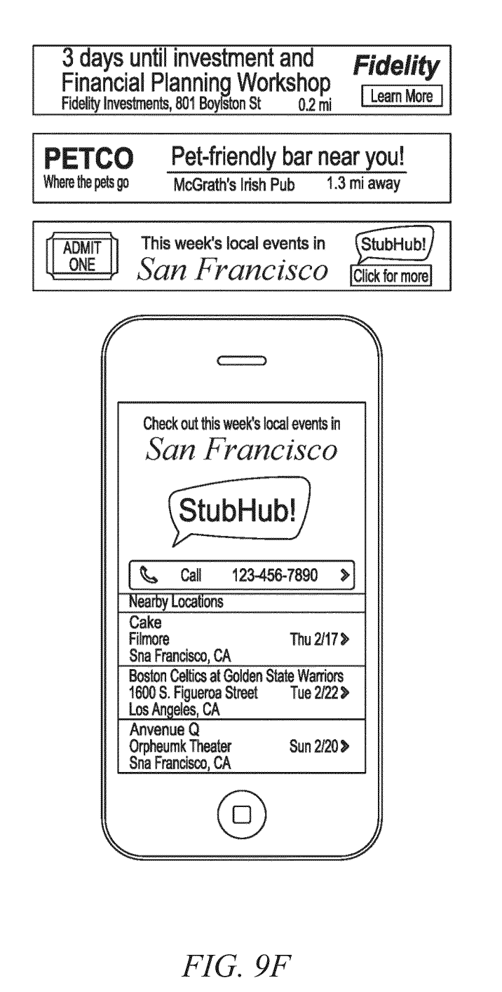

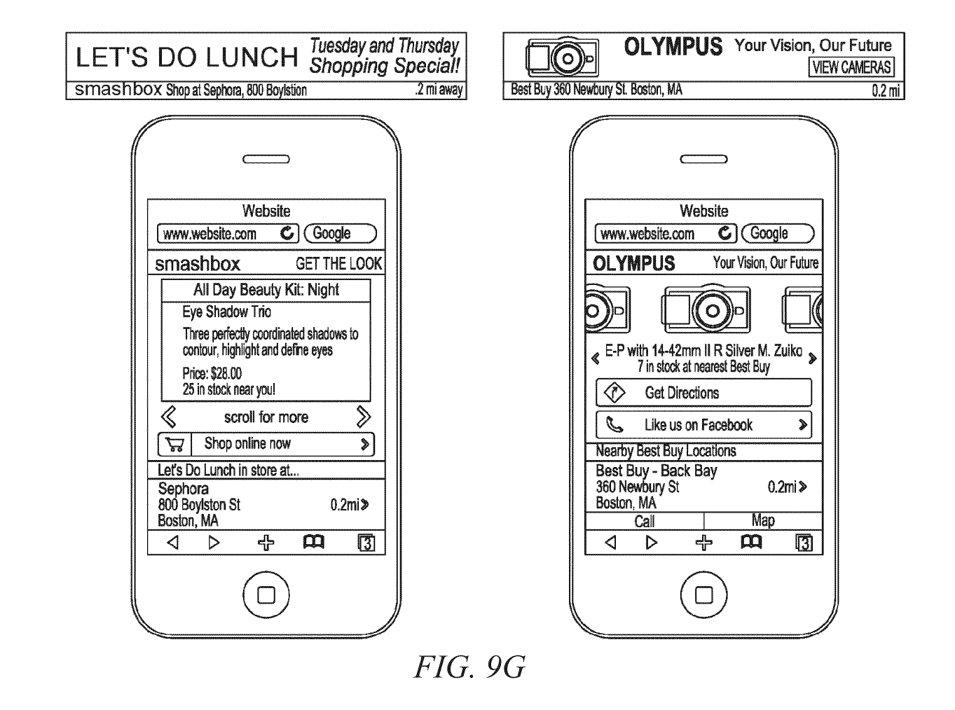

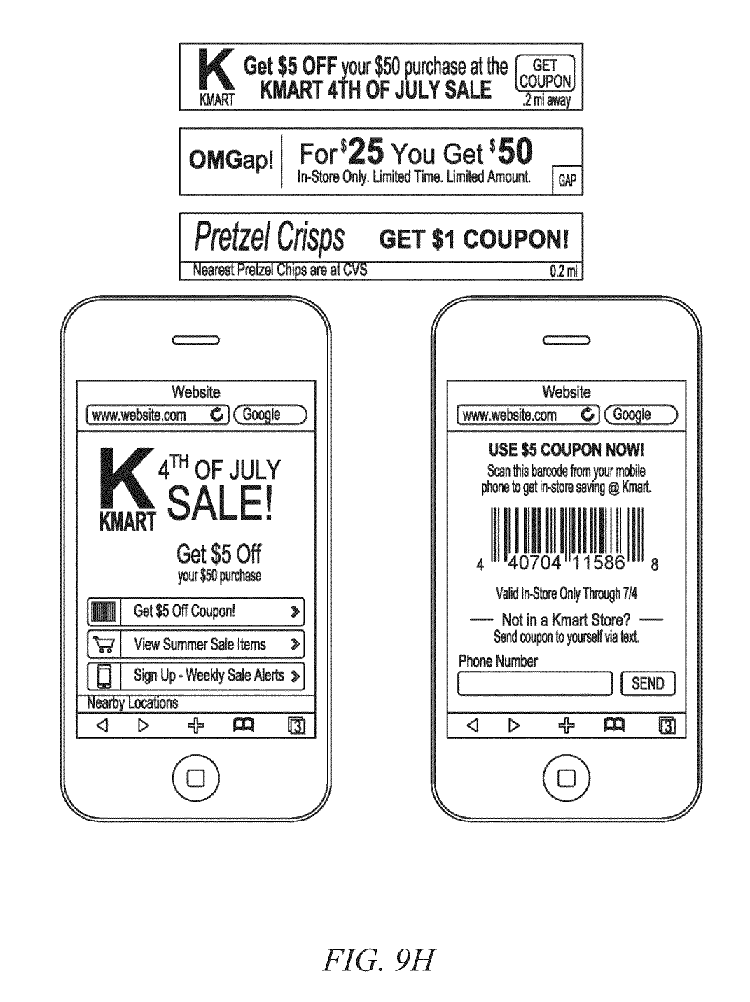

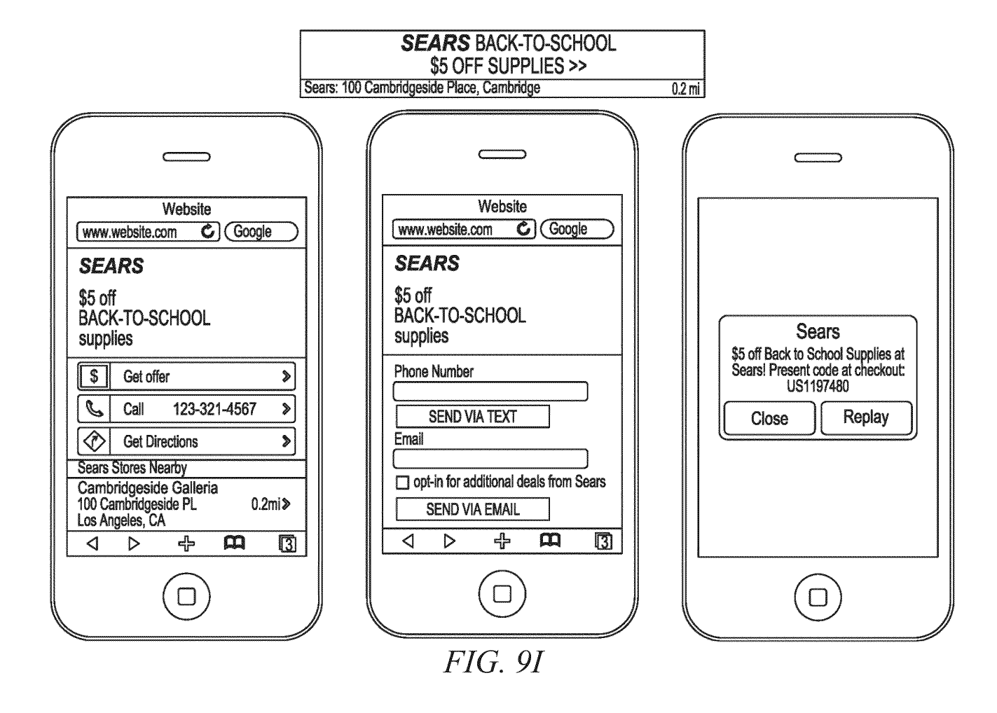

The method 700 can begin at 720 with the mobile device 115 receiving a context sensitive dynamic advertisement. In an example, the context sensitive dynamic advertisement can be received from a networked system, such as networked system 402. At 725, the method 700 can continue with the mobile device 115 displaying the advertisement. In an example, the context sensitive dynamic advertisement can be displayed as a banner ad within a mobile application. For additional examples of context sensitive dynamic advertisements, see FIGS. 9A through 9I.

At 740, the method 700 can optionally include the mobile device 115 transmitting updated location data (or user-related context data) to a service provider (e.g., networked system 402). At 730, the method 700 can continue with the mobile device 115 checking for receipt of updated advertisement content. If new advertisement content is received at 730, the method 700 can continue at 735 with the mobile device 115 updating the context sensitive dynamic advertisement with the updated content. In some examples, the entire advertisement is updated (e.g., replaced). In other examples, the mobile device 115 can merely update the dynamic portion of the advertisement. In yet other examples, the networked system 402 can push updated content directly to the dynamic advertisement.

Optionally, the method 700 can begin at 705 with the mobile device 115 running a location-aware application. At 710, the method 700 can optionally continue with the mobile device 115 detecting a current location. At 715, the method 700 can optionally continue with the mobile device 115 transmitting the current location data to a service provider. In an example, the service provider can operate the networked system 402.

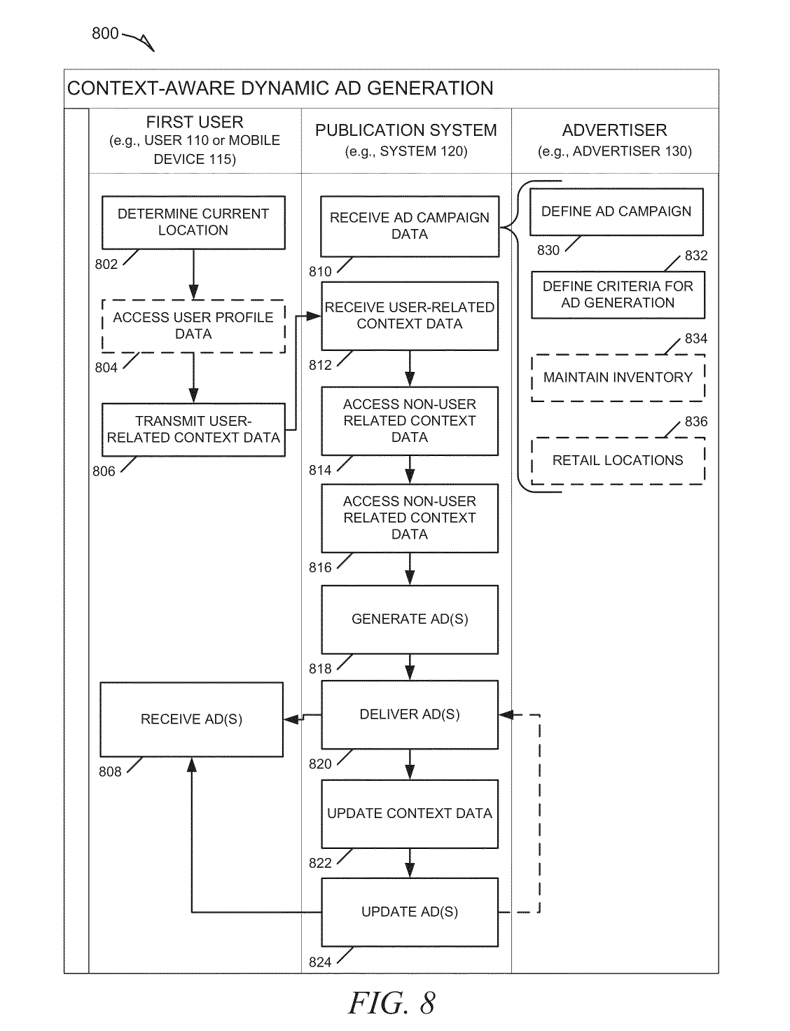

FIG. 8 is a swim-lane chart illustrating a method 800 for generating, delivering, and updating context sensitive dynamic mobile advertisements, according to an example embodiment. The method 800 illustrates example interactions between a user (e.g., mobile device 115), a networked system 402 (e.g., network-based publication system 120), and an advertiser (e.g., advertiser 130) in generating, delivering, and updating context sensitive advertisements, according to an example embodiment.

At 802, the method 800 can optionally begin with the mobile device 115 determining a current location associated with the mobile device. At 804, the method 800 can optionally continue with the mobile device 115 accessing user profile data. The user profile data can provide user-related context data that can be added to the current location data. At 806, the method 800 continues with the mobile device 115 transmitting user-related context data to a publication system, such as system 120.

In reference to system 110, the method 800 can begin at 810 with the system 120 receiving ad campaign data from an advertiser, such as advertiser 130. At 812, the method 800 can continue with the system 120 receiving the user-related context data generated by the mobile device 115. At 814, the method 800 can optionally continue with the system 120 determining a first user location (e.g., location of mobile device 115). At 816, the method 800 can continue with the system 120 accessing non-user related context data, such as the context data discussed above in reference to FIGS. 5 and 6 or Tables 1 and 2. In certain examples, the non-user related context data can, at least in part, be supplied by the advertiser, such as advertiser 130. In other examples, the non-user related context data is obtained from information source modules 552 through 562.

At 818, the method 800 can continue with the system 120 generating advertisements. At 820, the method 800 can continue with the system 120 delivering advertisements, such as to mobile device 115. At 808, the method 800 can include the mobile device 115 receiving the advertisements generated and transmitted by system 120. At 822, the method 800 can continue with the system 120 updating context data (e.g., user-related and non-user related context data). At 824, the method 800 can continue with the system 120 updating the advertisements based on updated context data.

In reference to advertiser 130, at 830 the method 800 can include the advertiser defining an advertising campaign to be implemented on system 120. At 832, the method 800 can include the advertiser 130 defining criteria for ad generation. At 834, the method 800 can optionally include the advertiser 130 maintaining inventory information. In an example, the inventory information can be used by system 120 to dynamically update advertisements containing inventory information. At 836, the method 800 can include the advertiser 130 maintaining a list of retail locations.

### Example Context Sensitive Dynamic Advertisements

FIG. 9A-9I are diagrams illustrating an example context sensitive dynamic mobile advertisements, according to various example embodiments.

FIG. 9A illustrates an example context sensitive dynamic mobile advertisement using dynamically updating location within a banner advertisement. In an example, physical location addresses and/or proximity can be automatically populated based on user (e.g., mobile device 115) location. The networked system 402 can track metrics on the dynamic advertisements, including click-throughs and call length (if a call is initiated based on the advertisement).

FIG. 9B illustrates an example context sensitive dynamic mobile advertisement using animated banner advertisements. Animated banner advertisements can include rotating graphics, rotating text, and fade transitions, among other things. Animated banner advertisements can also integrate other dynamically changing content, such as location.

FIG. 9C illustrates an example context sensitive dynamic mobile advertisement using countdown (or up) clock tracking time until an event. Context sensitive advertisements can also include a save to calendar function, allowing one-click to set a reminder in a user's personal calendar.

FIG. 9D illustrates an example context sensitive dynamic mobile advertisement using scrollable gallery advertisements to dynamically display location specific inventory for a participating merchant. Merchant can provide access to local inventory data or this data can be obtained from a third party provider, such as MILO. Gallery advertisements can include product, description, and price, among other things.

FIG. 9E illustrates an example context sensitive dynamic mobile advertisement using dynamic color and content. The color and content of a context sensitive advertisement can be dynamically changed based on location, events, user profile preferences, or flight delay data, among other things. For example, if the networked system 402 detects that a user is at an airport an advertisement for an airport vendor can be displayed with a color-changing background indicating flight delay status at the airport.

FIG. 9F illustrates an example context sensitive dynamic mobile advertisement using dynamic local content.

FIG. 9G illustrates an example context sensitive dynamic mobile advertisement displaying real-time inventory information.

FIG. 9H illustrates an example context sensitive dynamic mobile advertisement displaying merchant coupons. In an example, unique and non-unique coupon codes can be tracked using barcode or numeric codes scan-able at a POS. Coupon redemption tracking can also be performed by an application running on the mobile device.

FIG. 9I illustrates an example context sensitive dynamic mobile advertisement using POS enabled advertisements. In this example, the POS enabled advertisements use codes generated by First Data.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

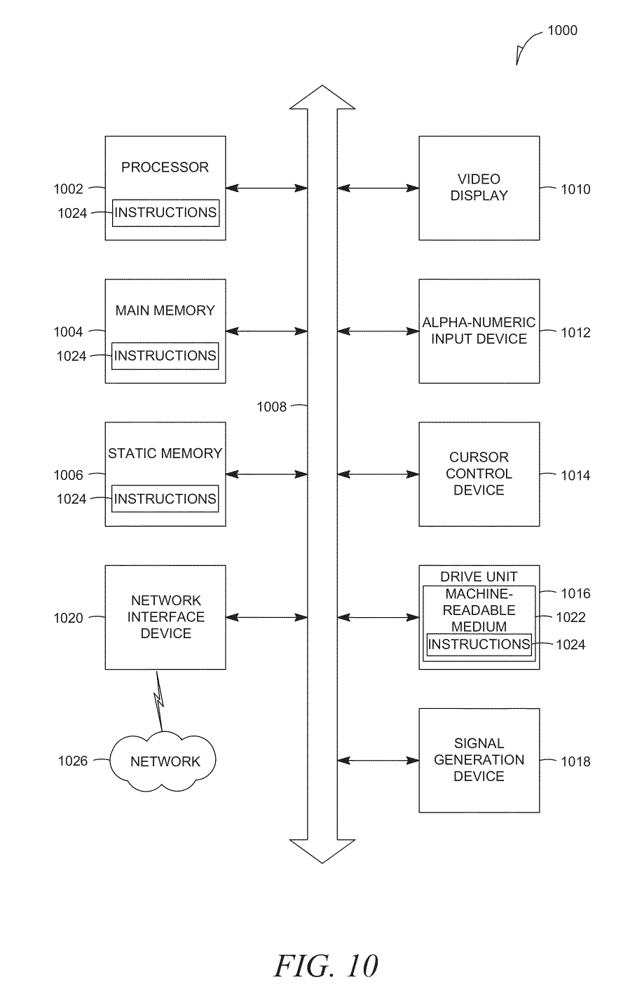

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or used by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for making contextual recommendations to users on a network-based marketplace have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The claimed invention includes:

1. A method comprising:
receiving, from a mobile device over a network, first context data;
generating, based at least in part on the first context data, a publication, the publication including a dynamic content portion to display dynamic data generated based at least in part on the first context data;
transmitting the publication over the network to the mobile device;
updating the dynamic content portion of the publication; and
transmitting at least the updated dynamic content portion of the publication over the network connection to the mobile device.

2. The method of claim 1, further comprising accessing second context data, and wherein the generating the dynamic content portion of the publication is based at least in part on the second context data.

3. The method of claim 2, wherein the accessing the second context data includes selecting second context data based at least in part on the first context data.

4. The method of claim 3, wherein the selecting second context data is based at least in part on location data included within the first context data, wherein the location data represents a current location of the mobile device.

5. The method of claim 2, wherein the second context data includes data selected from a group of data categories including:
points of interest;
events;
weather;
flight information;
stock alerts;
news;
inventory;
sports scores;
television listings; and
movie show times.

6. The method of claim 1, further comprising targeting a group of users based on second context data; and wherein the mobile device is associated with a user in the group of users.

7. The method of claim 6, further comprising;
updating the second context data;
re-targeting a second group of users based on the updated second context data; and
receiving, from a second mobile device associated with a second user selected from the second group of users, third context data;
generating, based at least in part on the third context data, a second publication, the second publication including a second dynamic content portion to display dynamic data related to the third context data;
transmitting the second publication over the network to the second mobile device;
updating the second dynamic content portion of the second publication; and
transmitting at least the second updated dynamic content portion of the second publication over the network to the second mobile device.

8. A machine-readable storage medium including instructions that, when executed by a machine, cause the machine to:
receive, from a mobile device over a network connection, first context data;
generate, based at least in part on the first context data, a publication, the publication including a dynamic content portion to display dynamic data related to the first context data;
transmit the publication over the network connection to the mobile device;
update the dynamic content portion of the publication; and
transmit at least the updated dynamic content portion of the publication over the network connection to the mobile device.

9. The machine-readable storage medium of claim 8, wherein the instructions further including instructions that cause the machine to access second context data, and wherein the instructions that cause the machine to generate the publication include instructions that cause the machine to generate the publication based at least in part on the second context data.

10. The machine-readable storage medium of claim 9, wherein the instructions that cause the machine to access the second context data include instructions that select second context data based at least in part on the first context data.

11. The machine-readable storage medium of claim 10, wherein the instructions that cause the machine to select second context data include instructions that cause the machine to select second context data based at least in part on location data included within the first context data, wherein the location data represents a current location of the mobile device.

12. The machine-readable storage medium of claim 9, wherein the second context data includes data selected from a group of data categories including:
points of interest;
events;
weather;
flight information;
stock alerts;
news;
inventory;
sports scores;
television listings; and
movie show times.

13. The machine-readable storage medium of claim 8, wherein the instructions further cause the machine to target a group of users based on second context data; and wherein the mobile device is associated with a user in the group of users.

14. The machine-readable storage medium of claim 13, wherein the instructions further cause the machine to:
update the second context data;
re-target a second group of users based on the updated second context data; and
receive, from a second mobile device associated with a second user selected from the second group of users, third context data;
generate, based at least in part on the third context data, a second publication, the second publication including a second dynamic content portion to display dynamic data related to the third context data;
transmit the second publication over the network connection to the second mobile device;
update the second dynamic content portion of the second publication; and
transmit at least the second updated dynamic content portion of the publication over the network connection to the second mobile device.

15. A system comprising:
a server including one or more processors, the one or more processors to, execute modules, and transmit, over a network connection to a mobile device, an publication and subsequent updates to at least a dynamic content portion of the publication, the modules including:
a content module configured to receive, from a mobile device over the network connection, first context data;
an ad generation module configured to generate, based at least in part on the first context data, the publication including a dynamic content portion to display dynamic data related to the first context data, and updates to the dynamic content portion of the publication.

16. The system of claim 15, wherein the content module accesses second context data, and wherein the ad generation module generates the publication based at least in part on the second context data.

17. The system of claim 16, wherein the content module selects second context data based at least in part on the first context data.

18. The system of claim 17, wherein the content module selects second context data based at least in part on location data included within the first context data, wherein the location data represents a current location of the mobile device.

19. The method of claim 16, wherein the content module selects the second context data from a group of data categories including:
points of interest;
events;
weather;
flight information;
stock alerts;
news;
inventory;
sports scores;
television listings; and
movie show times.

20. The method of claim 15, further comprising a targeting module configured to target a group of users based on the second context data; and wherein the mobile device is associated with a user in the group of users.
